(19) United States
(12) Patent Application Publication
(10) Pub. No.: US 2016/0069527 A1
(43) Pub. Date: Mar. 10, 2016

(54) VEHICLE LAMP

(71) Applicant: Koito Manufacturing Co., Ltd., Tokyo (JP)

(72) Inventor: Motohiro Komatsu, Shizuoka-shi (Shizuoka) (JP)

(21) Appl. No.: 14/834,627

(22) Filed: Aug. 25, 2015

(30) Foreign Application Priority Data
Sep. 5, 2014 (JP) 2014-181656

(51) Int. Cl. F21S 8/10

(52) U.S. Cl. CPC F21S 48/1291; F21S 48/1154; F21S 48/1258; F21S 48/1721; F21S 48/1742; F21S 48/1705; F21Y 2101/02

(57) ABSTRACT

Disclosed is a vehicle lamp including a projection lens and a plurality of light emitting devices arrangedtransversely in parallel to each other behind the projection lens. An additional high-beam light distribution pattern is additionally formed with respect to a low-beam light distribution pattern. The additional light distribution pattern is formed by projecting light emitted from each of the light emitting devices forward through the projection lens. At least one of the projection lens and the plurality of light emittingdevices is moved in a horizontal plane such that a formation position of the additional light distribution pattern is movable transversely.

### CROSS-REFERENCE TO RELATED APPLICATIONS

This application is based on and claims priority from Japanese Patent Application No. 2014-181656 filed on Sep. 5, 2014, with the Japan Patent Office, the disclosure of which is incorporated herein in its entirety by reference.

### TECHNICAL FIELD

The present disclosure relates to a projector type vehicle lamp.

### BACKGROUND

Conventionally, there is known a projector type vehicle lamp that is configured to projecting light from a light source located behind a projection lens forward through the projection lens.

Japanese Patent Laid-Open Publication No. 2011-249080 discloses a vehicle lamp, in which an additional high-beam light distribution pattern is additionally formed with respect to a low-beam light distribution pattern.

The vehicle lamp includes a plurality of light emitting devices arrangedtransversely in parallel to each other as a light source and forms a transversely elongated additional light distribution pattern by projecting light emitted from each of the light emitting devices forward through the projection lens.

### SUMMARY

In the vehicle lamp described in Japanese Patent Laid-Open Publication No. 2011-249080, since the positions of the projection lens and the plurality of light emitting devices are fixed, the formation position of the additional light-distribution pattern is also fixed. Therefore, when the own vehicle travels on a curved road, the front side in the traveling direction is not sufficiently irradiated.

In order to solve the problem, a configuration may be considered, in which light emitting devices are additionally arranged to irradiate the front side in the traveling direction when turning, and their turning ON/OFF is controlled. However, when such a configuration is employed, the cost of the lamp may increase by the additional portion of the light emitting devices.

The present disclosure has been made in consideration of such a situation and has an object to provide a vehicle lamp in which an additional high-beam light distribution pattern is formed by projecting light emitted from a plurality of light emitting devices forward through a projection lens, so that the additional light distribution pattern capable of sufficiently irradiating the front side in the traveling direction when turning may be formed at a low cost.

The present disclosure is to achieve the object described above by providing a movable vehicle lamp.

A vehicle lamp according to the present disclosure includes a projection lens; and a plurality of light emitting devices arrangedtransversely in parallel to each other behind the projection lens. In the vehicle lamp, an additional high-beam light distribution pattern is additionally formed with respect to a low-beam light distribution pattern. The additional light distribution pattern is formed by projecting light emitted from each of the light emitting devices forward through the projection lens. At least one of the projection lens and the plurality of light emittingdevices is moved in a horizontal plane such that a formation position of the additional light distribution pattern is movable transversely.

The kind of the “light emitting device” is not particularly limited and, for example, a light emitting diode or a laser diode may be employed.

The “projection lens” or the “plurality of light emitting devices” is not particularly limited in terms of the movement aspect as long as the formation position of the additional light distribution pattern is movable transversely by the movement.

As illustrated in the above-described configuration, the vehicle lamp according to the present disclosure is configured such that the additional high-beam light distribution pattern is formed by projecting light emitted from each of the plurality of light emitting devices, which is arrangedtransversely in parallel to each other behind the projection lens, forward through the projection lens. However, since at least one of the projection lens and the plurality of light emittingdevices is moved in a horizontal plane such that a formation position of the additional light distribution pattern is movable transversely, the front of the own vehicle may be sufficiently irradiated in the traveling direction when the vehicle travels on a curved road.

Furthermore, it is not necessary to arrange additional light emitting devices and control their turning ON/OFF as in the prior art. Therefore, the increase in cost of the vehicle lamp may be effectively suppressed.

According to the present disclosure, in a vehicle lamp, in which an additional high-beam light distribution pattern is formed by projecting light emitted from a plurality of light emitting devices forward through a projection lens, the additional light distribution pattern is capable of sufficiently irradiating the front side in the traveling direction when turning may be formed at a low cost.

In the above-described configuration, when the plurality of light emitting devices is configured to be individually turned ON/OFF, the following acting effect may be acquired.

That is, the plurality of light emitting devices is turned ON at the same time to form an additional light distribution pattern, which may be suitable for the high-beam light distribution pattern. Meanwhile, some of the plurality of light emitting devices may be selectively tuned ON to form an additional light distribution pattern omittinga part of the above-mentioned additional light distribution pattern, which may be suitable for formation of an intermediate light distribution pattern located in the middle of the low-beam light distribution pattern and the high-beam light distribution pattern. In addition, when such an intermediate light distribution pattern is formed, a front traveling road may be irradiated as widely as possible within a range that does not impart glare to a driver of an oncoming vehicle.

In the above-described configuration, when the projection lens and the plurality of light emitting devices are configured to be integrally pivoted in the horizontal plane, the formation position of the additional light distribution may be moved transversely while maintaining the shape of the additional light distribution pattern as it is.

In the above-described configuration, when the projection lens and the plurality of light emitting devices are configured to be relatively movable transversely, an object to be moved may be lightened in weight, and thus, a moving mechanism may be simplified to that extent.

In the above-described configuration, when a ratio of supply current values of respective light emitting devices is configured to be changed as the formation position of the additional light distribution pattern is moved transversely, the front of the own vehicle may be efficiently irradiated in the traveling direction when the own vehicle travels on a curved road. Accordingly, the generally limited supply current is effectively utilized so that the visibility of the curved road may be enhanced.

The above-described summary is illustration purposes only and does not intend to limit in any ways. In addition to the illustrative embodiment, examples, and features described above, additional embodiment, example, and features will become apparent by referring to the drawings and the following detailed description.

### BRIEF DESCRIPTION OF THE DRAWINGS

FIG. 1 is a front view illustrating a vehicle lamp according to an exemplary embodiment of the present disclosure.

FIG. 2 is a sectional view taken along line II-II in FIG. 1.

FIG. 3 is a sectional view taken along line III-III in FIG. 1.

FIG. 4 is a perspective view illustrating a main portion of the vehicle lamp.

FIGS. 5A to 5E are graphs illustrating supply current valuesforrespective light emitting devices of the vehicle lamp.

FIGS. 6A and 6B are perspective views illustrating an additional light distribution pattern formed by light projected from the vehicle lamp when the own vehicle travels straight.

FIGS. 7A and 7B are the same views as FIGS. 6A and 6B, illustrating an additional light distribution pattern when the own vehicle turns left.

FIGS. 8A and 8B are the same views as FIGS. 6A and 6B, illustrating an additional light distribution pattern when the own vehicle turns right.

FIG. 9 is the same view as FIG. 3, illustrating a vehicle lamp according to a first modification of the exemplary embodiment.

FIG. 10 is the same view as FIG. 3 illustrating a vehicle lamp according to a second modification of the exemplary embodiment.

### DETAILED DESCRIPTION

In the following detailed description, reference is made to the accompanying drawing, which form a part hereof. The illustrative exemplary embodiments described in the detailed description, drawings, and claims are not meant to be limiting. Other exemplary embodiments may be utilized, and other changes may be made, without departing from the spirit or scope of the subject matter presented here.

Hereinafter, exemplary embodiments of the present disclosure will be described with reference to the accompanying drawings.

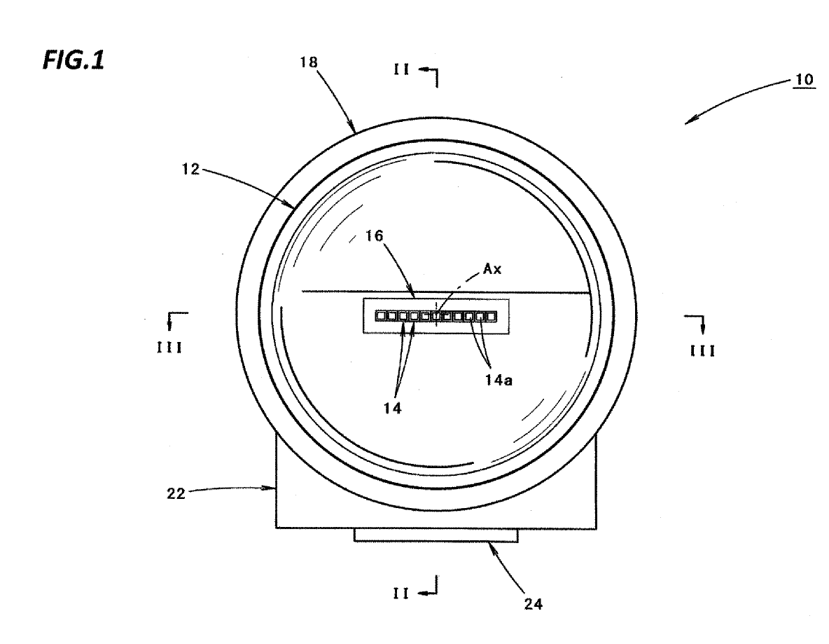

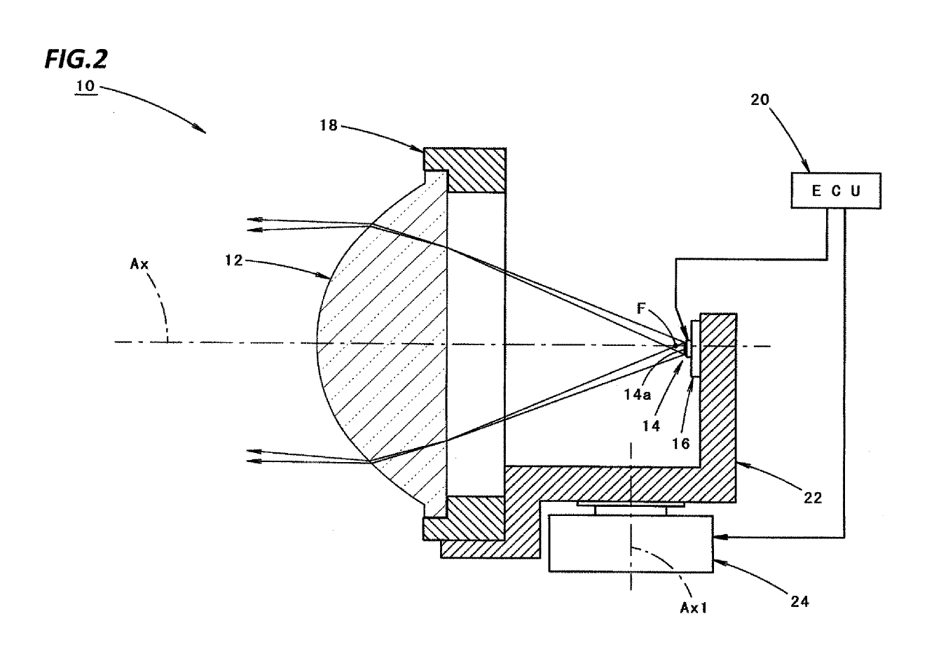

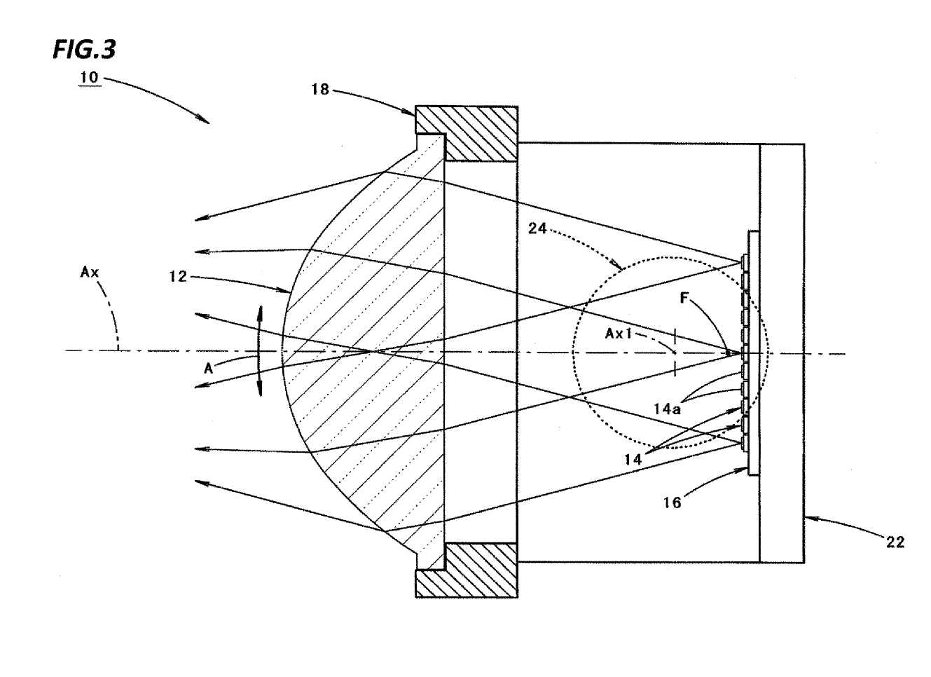

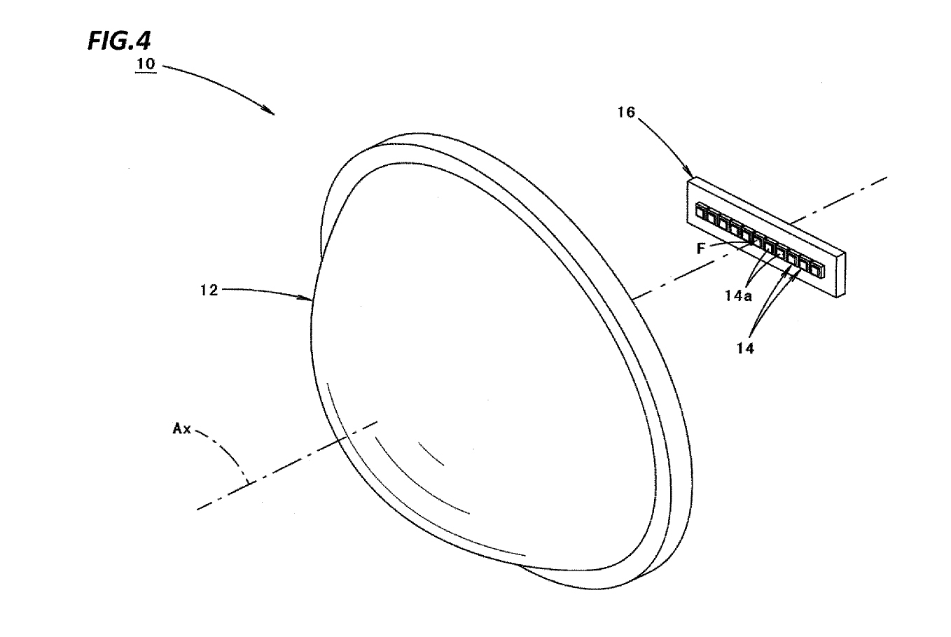

FIG. 1 is a front view illustrating a vehicle lamp 10 according to an exemplary embodiment of the present disclosure. FIG. 2 is a cross-sectional view taken along line II-II in FIG. 1, and FIG. 3 is a sectional view taken along line III-III in FIG. 1. Further, FIG. 4 is a perspective view illustrating a main portion of the vehicle lamp.

As illustrated in the figures, the vehicle lamp 10 is a projector type vehicle lamp that is configured to additionally form an additional high-beam light distribution pattern with respect to a low-beam light distribution pattern.

The vehicle lamp 10 includes a projection lens 12 having an optical axis Ax extending in a longitudinal direction of the vehicle, and a plurality of light emitting devices 14 arrangedtransversely in parallel to each other behind the projection lens 12, so that light emitted from each of thelight emitting devices 14 is projected forward through the projection lens 12.

The projection lens 12 is a plano-convex aspherical lens having a convex front surface and a flat rear surface. The projection lens 12 is configured to project a light source image, which is formed on a rear focal plane that is a focal plane including a rear focal point F, to a virtual vertical screen in front of the lamp as a reversed image. The projection lens 12 is supported by a lens holder 18 in its peripheral flange.

The plurality of light emitting devices 14 is arranged transversely in parallel to each other slightly behind the rear focal point F of the projection lens 12. In the present exemplary embodiment, eleven light emitting devices 14, all having the same configuration, are arranged at equal intervals from the left and right sides of the optical axis Ax as a center.

Each of the light emitting devices 14 is a white light emitting diode and has a rectangular (e.g., square) light emitting surface 14a. In addition, each of the light emitting devices 14 is supported on a common substrate 16 in a state where the light emitting surfaces 14a face the front side of the vehicle lamp. Here, each of the light emitting devices 14 is arranged in a state where the center of the light emitting surface 14a is located slightly below the optical axis Ax and the upper edge is located slightly above the optical axis Ax.

The light emitted from each of the light emitting devices 14 towards the projection lens 12 passes through the rear focal point surface with a certain degree of spread so that the ranges of light beamsare slightly overlapped between adjacent light emitting devices 14.

The eleven light emitting devices 14 are configured to be capable of being individually turned ON. To realize this, the eleven light emitting devices 14 are connected to an electronic control unit (ECU) 20 as illustrated in FIG. 2, and their turning-ON/OFF is performed by the electronic control unit 20 depending on the traveling situation of the own vehicle.

The vehicle lamp 10 according to the present exemplary embodiment has a configuration in which the projection lens 12 and the eleven light emitting devices 14 are integrally pivotable within the horizontal plane.

That is, in the present exemplary embodiment, the lens holder 18 and the substrate 16 are supported on a common base member 22, and the base member 22 is supported by a pivoting mechanism 24.

As illustrated by the arrow A in FIG. 3, the pivoting mechanism 24 pivots the projection lens 12 and the eleven light emitting device 14 together with the base member 22 around an axis Ax1 that extends vertically. The axis Ax1 extends to intersect the optical axis Ax behind the projection lens 12 and ahead the rear focal point F.

The pivoting mechanism 24 is supported on a lamp body (not illustrated), and the driving control thereof is performed by the electronic control unit 20 depending on the traveling situation of the own vehicle.

In the present exemplary embodiment, supply current values for respective light emitting devices 14 areequal to each other, but the ratio thereof is set to be changed depending on the traveling situation of the own vehicle. At that time, the control of the supply current values is also performed by the electronic control unit 20 depending on the traveling situation of the own vehicle.

Further, the traveling situation of the own vehicle may be grasped based on a detection value such as, for example, steering angle data of the own vehicle, navigation data, and image data of the front traveling road.

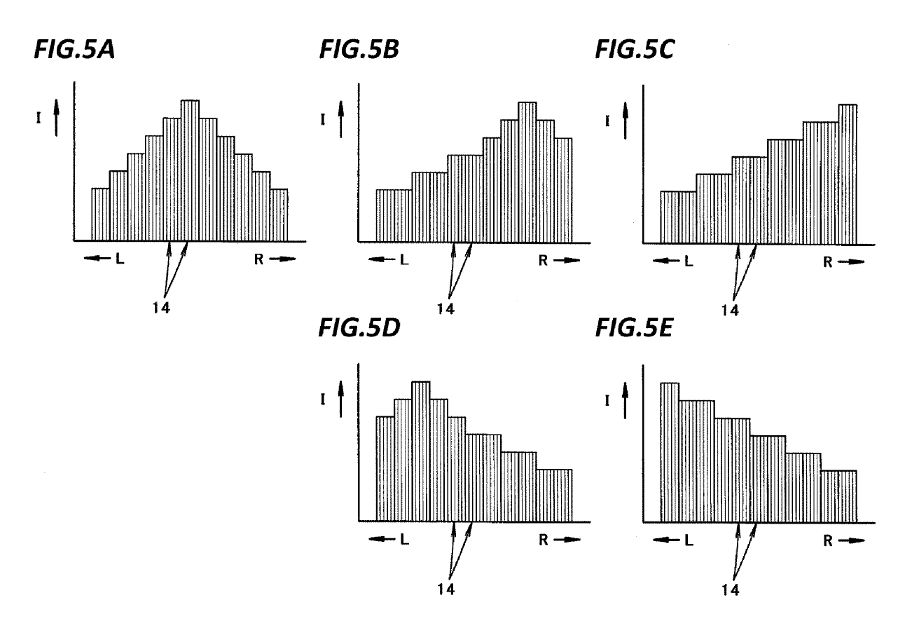

FIGS. 5A to 5E are graphs illustrating supply current values I for respectivelight emitting devices 14.

As illustrated in FIG. 5A, when traveling straight, the distribution of supply current values I for respectivelight emitting devices 14 is formed in a symmetrical mountain-like shape. That is, the supply current value I for the light emitting device 14 locatedat the center is the largest, the supply current values I gradually decrease toward the left and right sides thereof, and the supply values I for the light emitting devices 14 located at the left and right ends are the smallest.

As illustrated in FIG. 5B, when turning left, the distribution of the supply current values I for respectivelight emitting devices 14 is formed in a shape of a mountain with a steeper slope on the right side. That is, the supply current value I for the light emitting device 14 slightly spaced apart from the center to the right side is the largest, the supply current values I gradually decrease toward the left and right sides, and the supply value I for the light emitting device 14 located at the left end is the smallest.

As illustrated in FIG. 5C, in a case where the front traveling road is curved sharply when turning left, the distribution of the supply current values I for respectivelight emitting devices 14 is formed in a shape inclined to the left side. That is, the supply current value I for the light emitting device 14 located at the right end is the largest, the supply current values I gradually decrease toward the left side, and the supply value I for the light emitting device 14 located at the left end is the smallest.

Meanwhile, as illustrated in FIG. 5D, when turning right, the distribution of the supply current valuesI for respectivelight emitting devices 14 areformed in a shape of a mountain with a steeper slope on the left side.

Further, as illustrated in FIG. 5E, in a case where the front traveling road is curved sharply when turning right, the distribution of the supply current values I for respectivelight emitting devices 14 is formed in a shape inclined to the right side.

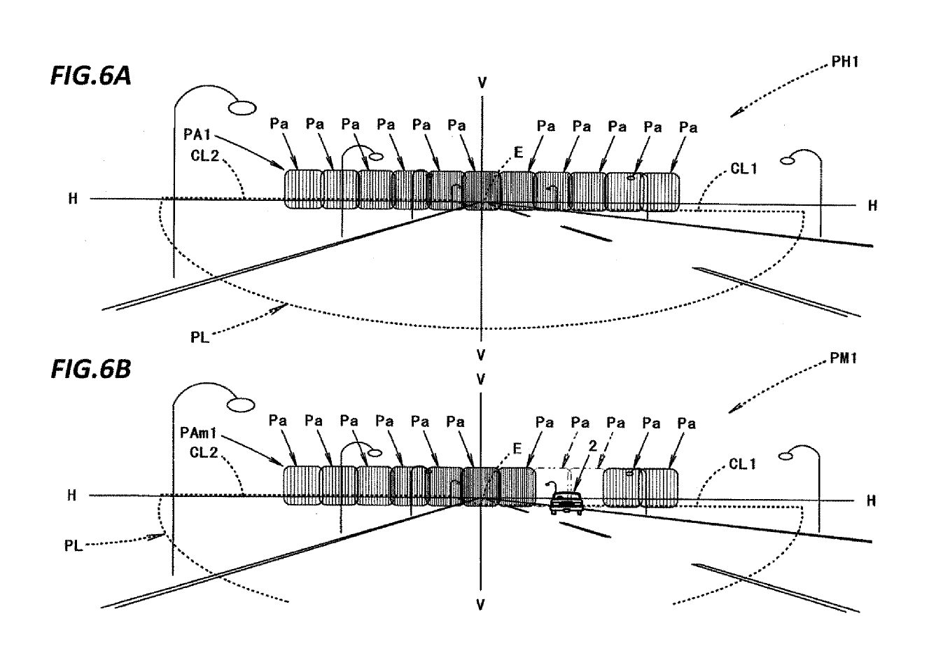

FIGS. 6A and 6B are perspective views illustrating an additional light distribution pattern formed on a virtual vertical screen located at a position 25 m ahead the vehicle lamp by light projected forward from the vehicle lamp 10, in a state where the own vehicle travels on a straight road.

Here, FIG. 6A is a view illustrating an additional light distribution pattern PA1 of a high-beam light distribution pattern PH1, and FIG. 6B is a view illustrating an additional light distribution PAm1 of an intermediate light distribution pattern PM1.

The high-beam light distribution pattern PH1 illustrated in FIG. 6A is formed by adding the additional light distribution pattern PA1 formed by the light projected from the vehicle lamp 10 to a low-beam light distribution pattern PL formed by light projected from other lamp units (not illustrated).

The low-beam light distribution pattern PL is a low-beam light distribution pattern for left light distribution and has left and right unlevel cutoff lines CL1 and CL2 in the upper edge thereof. The cutoff lines CL1 and CL2 horizontally extend with a height difference at the left and right sides of a boundary line V-V vertically passing a vanishing point H-V in front of the lamp. An opposite lane side portion at the right side of the line V-V is formed as the lower level cutoff line CL1 and an own lane side portion is formed as the upper level cutoff line CL2 of which the level is raised from the lower level cutoff line CL1 via a slope.

In the low-beam light distribution pattern PL, an elbow point E that is an intersection point of the lower level cutoff line CL1 and the line V-V is located below H-V by about 0.5° to 0.6°.

The additional light distribution pattern PA1 is formed as a horizontally elongated light distribution pattern that widens upward from the cutoff lines CL1 and CL2. At this time, the additional light distribution pattern PA1 is formed so as to evenly widen from the left and right sides of the line V-V as a center. And, when the additional light distribution pattern PA1 is additionally formed with respect to the low-beam light distribution pattern PL, the high-beam light distribution pattern PH1 is formed to widely irradiate the front traveling road.

The additional light distribution pattern PA1 is formed as a composite light distribution pattern of eleven light distribution patterns Pa.

Each of the light patterns Pa is a light distribution pattern formed as a reversed projection image of a light source image of each of the light emitting devices 14 formed on the rear focal plane of the projection lens 12 by the light emitted from the light emitting device 14.

Here, each light distribution pattern Pa has a substantially rectangular shape, which corresponds to the rectangular shape of the light emitting surface 14a of each of the light emitting devices 14.

Further, each of the light distribution patterns Pa is formed such that adjacent light distribution patterns Pa are slightly overlapped with each other. This is because each of the light emitting devices 14 is arranged slightly behind the rear focal point of the projection lens 12 and the ranges of light beamspassing the rear focal plane are slightly overlapped between adjacent light emitting devices 14.

Further, each of the light distribution patterns Pa is formed to be slightly overlapped with the cutoff lines CL1 and CL2 at the lower edge thereof. This is because the center of the light emitting surface 14a of each of the light emitting devices 14 is located slightly below the optical axis Ax and the upper edge thereof is located slightly above the optical axis Ax.

Among the eleven light distribution patterns Pa, the light distribution pattern Pa located at the center is the brightest, the light distribution patterns Pa adjacent to the left and right sides of the centerare the next brightest, and the brightness gradually decreases toward the light distribution patterns Pa located at the left and right ends.

This is because the distribution of the supply current values I for respectivelight emitting devices 14 is formed in a symmetrical mountain-like shape, as illustrated in FIG. 5A.

Whenthe additional light distribution pattern PA1 having such a luminosity distribution is formed, the generally limited supply current is effectively utilized so that the visibility of the high-beam light distribution pattern PH1 at the time of traveling straight may be enhanced.

The intermediate light distribution pattern PM1 illustrated in FIG. 5B is a light distribution pattern having,in place of the additional light distribution pattern PA1, an additional light distribution pattern PAm1 in which a part of the additional light distribution pattern PA1 is omitted, with respect to the high-beam light distribution pattern PH1.

Specifically, the additional light distribution pattern PAm1 is a light distribution pattern in which the third and fourth light distribution patterns Pa from the right side among the eleven light distribution patterns Pa are omitted. The additional light distribution pattern PAm1 is formed by turning OFF the third and fourth light emitting devices 14 from the left side among the eleven light emitting devices 14.

When the additional light distribution pattern PAm1 is formed, the front traveling road may be irradiated as widely as possible within a range in whichthe light projected from the vehicle lamp 10 does not reach an oncoming vehicle 2 and thus no glare is imparted to thedriver of the oncoming vehicle 2.

In addition, as the position of the oncoming vehicle 2 is changed, the light emitting devices 14 to be turned OFF are sequentially switched so that the shape of the additional light distribution pattern PAm1 is changed, thereby maintaining the statewhere the front traveling road is irradiated as widely as possible within a range that does not impart glare to the driver of the oncoming vehicle 2.

Further, the presence of the oncoming vehicle 2 is detected by avehicle-mounted camera (not illustrated). In addition, even in a case where the last traveling vehicle is present on the front traveling road or a pedestrian is present in the shoulder area, when the vehicle or the pedestrian is detected, some of the light distribution patterns Pa are adapted to be omitted so as not to impart glare.

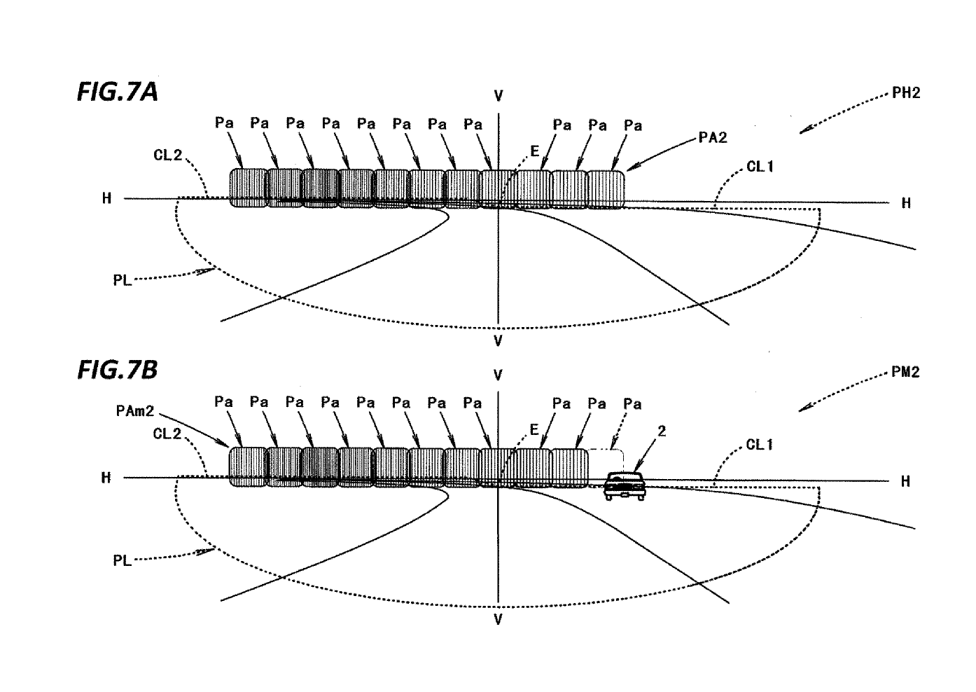

FIGS. 7A and 7B are perspective views illustrating an additional light distribution pattern formed on the virtual vertical screen by light projected from the vehicle lamp 10, in a state where the own vehicle travels on a left-curved road (that is, a road curved to the left).

Here, FIG. 7A is a view illustrating an additional light distribution pattern PA2 of a high-beam light distribution pattern PH2, and FIG. 7B is a view illustrating an additional light distribution PAm2 of an intermediate light distribution pattern PM2.

In the additional light distribution pattern PA2 illustrated in FIG. 7A, the formation position thereof is changed to the left side with respect to the additional light distribution pattern PA1 illustrated in FIG. 6A, and the peak position of the luminosity distribution is changed to the position of the third light distribution pattern Pa from the left side.

The change of the formation position of the additional light distribution pattern PA2 is performed by pivoting the projection lens 12 and the eleven light emitting devices 14 to the left by driving the pivoting mechanism 24. Further, the change of the peak position of the luminosity distribution of the additional light distribution pattern PA2 is performed by setting the supply current values I for respectivelight emitting devices 14 to have a distribution in a form of a mountain with a steeper slope on the right side as illustrated in FIG. 5B.

When the additional light distribution pattern PA2 is formed, the generally limited supply current is effectively utilized when turning left so that the front side in the traveling direction may be sufficiently irradiated.Accordingly, the visibility of the high-beam light distribution pattern PH2 may be enhanced.

When the left-curved road is curved sharply, the peak position of the luminosity distribution of the additional light distribution pattern PA2 is changed further to the left side by setting the supply current values I for respectivelight emitting devices 14 to have a distribution inclined to the left side as illustrated in FIG. 5C.

The intermediate light distribution pattern PM illustrated in FIG. 7B is a light distribution pattern having, in place of the additional light distribution pattern PA2, an additional light distribution pattern PAm2 in which a part of the additional light distribution pattern PA2 is omitted, with respect to the high-beam light distribution pattern PH2.

Specifically, the additional light distribution pattern PAm2 is a light distribution pattern in which the first light distribution pattern Pa from the right side among the eleven light distribution patterns Pa is omitted. The additional light distribution pattern PAm2 is formed by turning OFF the first light emitting device 14 from the left side among the eleven light emitting devices 14.

When the intermediate light distribution pattern PM2 is formed, the front traveling road may be irradiated as widely as possible within a range in which the light projected from the vehicle lamp 10 does not reach the oncoming vehicle 2 and thus no glare is imparted to the driver of the oncoming vehicle 2.

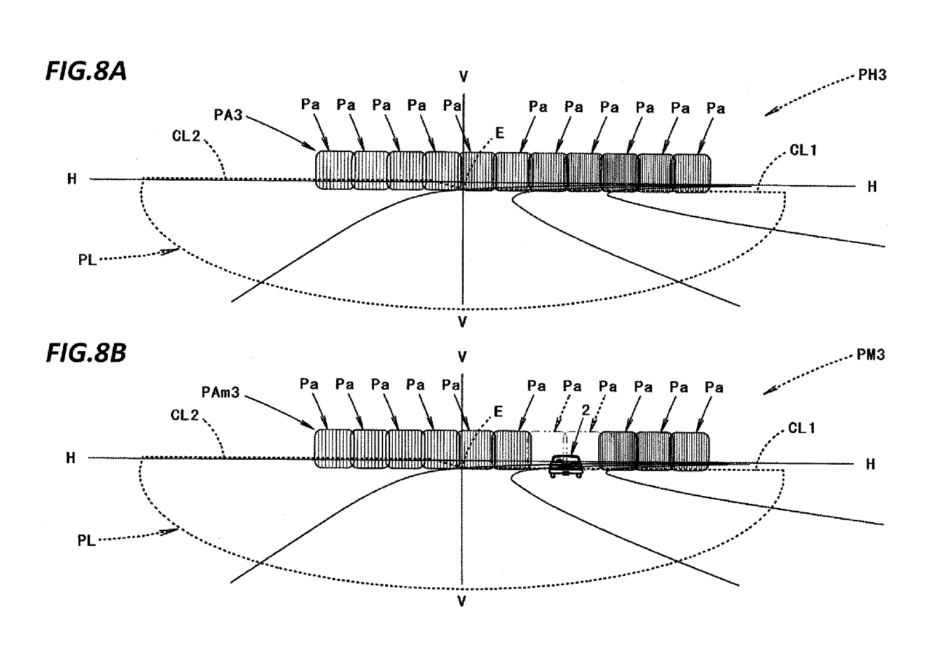

FIGS. 8A and 8B are perspective views illustrating an additional light distribution pattern formed on the virtual vertical screen by light projected from the vehicle lamp 10, in a state where the own vehicle travels on a right-curved road (that is, a road curved to the right).

Here, FIG. 8A is a view illustrating an additional light distribution pattern PA3 of a high-beam light distribution pattern PH3, and FIG. 8B is a view illustrating an additional light distribution PAm3 of an intermediate light distribution pattern PM3.

In the additional light distribution pattern PA3 illustrated in FIG. 8A, the formation position thereof is changed to the right side with respect to the additional light distribution pattern PA1 illustrated in FIG. 6A, and the peak position of the luminosity distribution is changed to the position of the third light distribution pattern Pa from the right side.

The change of the formation position of the additional light distribution pattern PA3 is performed by pivoting the projection lens 12 and the eleven light emitting devices 14 to the right by driving the pivoting mechanism 24. Further, the change of the peak position of the luminosity distribution of the additional light distribution pattern PA3 is performed by setting the supply current values I for respectivelight emitting devices 14 to have a form of a mountain with a steeper slope on the left side as illustrated in FIG. 5D.

When the additional light distribution pattern PA3 is formed, the generally limited supply current when turning right is effectively utilized, so that the front side may be sufficiently irradiated in the traveling direction. Accordingly, the visibility of the high-beam light distribution pattern PH3 may be enhanced.

When the right-curved road is curved sharply, the peak position of the luminosity distribution of the additional light distribution pattern PA2 is changed further to the right side by setting the supply current values I for respectivelight emitting devices 14 to have a distribution inclined to the right side as illustrated in FIG. 5E.

The intermediate light distribution pattern PM3 illustrated in FIG. 8B is a light distribution pattern having, in place of the additional light distribution pattern PA3, an additional light distribution pattern PAm3 in which a part of the additional light distribution pattern PA3 is omitted, with respect to the high-beam light distribution pattern PH3.

Specifically, the additional light distribution pattern PAm3 is a light distribution pattern in which the fourth and fifth light distribution patterns Pa from the right side among the eleven light distribution patterns Pa are omitted. The additional light distribution pattern PAm3 is formed by turning OFF the fourth and fifthlight emitting devices 14 from the left side among the eleven light emitting devices 14.

When the intermediate light distribution pattern PM3 is formed, the front traveling road may be irradiated as widely as possible within a range in which the light projected from the vehicle lamp 10 does not reach the oncoming vehicle 2 and thus no glare is imparted to the driver of the oncoming vehicle 2.

Next, acting effects of the present exemplary embodiment will be described.

The vehicle lamp 10 according to the present exemplary embodiment is configured to form the additional high-beam light distribution pattern PA1 by projecting the light emitted from each of the plurality of light emitting devices 14, which is arranged transversely in parallel to each other behind the projection lens 12, forward through the projection lens 12. However, since the formation position of the additional light distribution patterns PA2 and PA3 is movable transversely by integrally pivoting the projection lens 12 and the plurality of light emitting devices 14 in the horizontal plane, the front side may be sufficiently irradiated in the traveling direction when the own vehicle travels on a curved road.

Furthermore, it is not necessary to additionally arrange thelight emitting devices 14 and control their turning ON/OFF as in the prior art. Therefore, the increase in cost of the vehicle lamp may be effectively suppressed.

According to the present exemplary embodiment, in the vehicle lamp 10 configured to form an additional high-beam light distribution pattern PA1 by projecting the light emitted from the plurality of light emitting devices 14 forward through the projection lens 12, additional light distribution patterns PA2 and PA3 capable of sufficiently irradiating the front side in the traveling direction when turning may be formed at a low cost.

Furthermore, in the present exemplary embodiment, since the plurality of light emitting devices 14 is individually turned ON, the following acting effects may be obtained.

That is, the plurality of light emitting devices 14 is turned ON at the same time to form the additional light distribution patterns PA1, PA2, PA3, which may be suitable for the high-beam light distribution patterns PH1, PH2, PH3. Meanwhile, some of the plurality of light emitting devices 14 may be selectively tuned ON to form the additional light distribution patterns PAm1, PAm2, PAm3omitting a part of the above-mentioned additional light distribution pattern, which may be suitable for formation of the intermediate light distribution patterns PM1, PM2, PM3arranged in the middle of the low-beam light distribution pattern PL and the high-beam light distribution patterns PH1, PH2, PH3. In addition, when the intermediate light distribution patternsPM1, PM2, PM3 are formed, the front traveling road may be irradiated as widely as possible within a range that does not impart glare to a driver of an oncoming vehicle.

Further, in the present exemplary embodiment, since the projection lens 12 and the plurality of light emitting devices 14 are configured to be integrally pivoted in the horizontal plane, the formation position of the additional light distribution may be moved transversely while maintaining the shapes of the additional light distribution patterns PA1, PA2, PA3, PAm1, PAm2, PAm3 as they are.

In the present exemplary embodiment, since a ratio of the supply current values I of respectivelight emitting devices 14 is configured to be changed as the formation positions of the additional light distribution patternsPA1, PA2, PA3, PAm1, PAm2, PAm3 are moved transversely, the front side of the own vehicle may be efficiently irradiated in the traveling direction when the own vehicle travels on a curved road. Accordingly, the generally limited supply current is effectively utilized so that the visibility of the curved road may be enhanced.

In the above-described exemplary embodiment, it is described that a ratio of the supply current value I of each of the light emitting devices 14 is configured to be changed as the formation positions of the additional light distribution patterns PA1, PA2, PA3, PAm1, PAm2, PAm3 are moved transversely. However, the supply current value I for each of the light emitting devices 14 may be always constantly maintained.

In the above-described exemplary embodiment, eleven light emitting devices 14 are provided. However, any other number of light emitting devices 14 may be provided.

In the above-described exemplary embodiment, each of the light emitting devices 14 is arranged behind the rear focal point F of the projection lens 12. However, each of the light emitting devices 14 may be arranged ahead the rear focal point F.

Next, modifications of the above-described exemplary embodiment will be described.

First, a first modification of the above-described exemplary embodiment will be described.

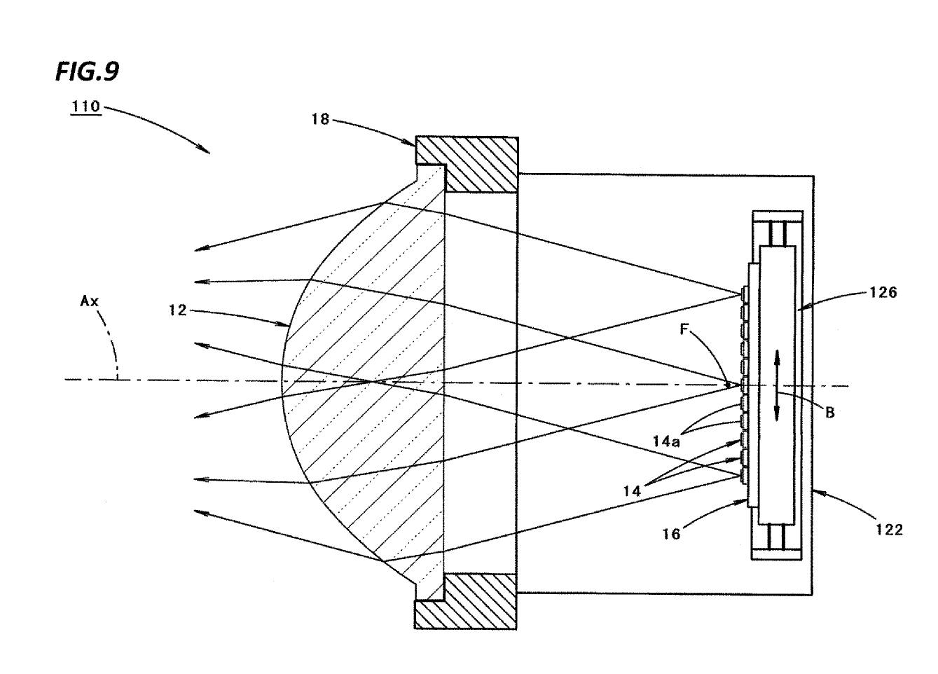

FIG. 9 is the same view as FIG. 3, illustrating a vehicle lamp 110 according to the present modification.

As illustrated in FIG. 9, a basic configuration of the vehicle lamp 110 is the same as that of the vehicle lamp 10 of the above-described exemplary embodiment, but a configuration around a base member 122 is different from the case of the above-described exemplary embodiment.

That is, in the present modification, the base member 122 is supported directly on a lamp body (not illustrated) without the pivoting mechanism 24 of the above-described exemplary embodiment. Further, the lens holder 18 supporting the projection lens 12 is supported directly on the base member 122. However, the substrate 16 supporting the eleven light emitting devices 14 is supported on the base member 122 via a sliding mechanism 126 to be reciprocally movable in the transverse direction, as indicated by the arrow B in FIG. 9.

In addition, in the present modification, the additional light distribution patterns PA2, PA3, PAm2, PAm3 are displaced transversely with respect to the additional light distribution patterns PA1, PAm1 by moving the plurality of light emitting devices 14 transversely by driving the sliding mechanism 126 depending on the traveling situation of the own vehicle.

Even in a case where the configuration of the present modification is employed, it is possible to obtain substantially the same acting effect as in the above-described exemplary embodiment.

Further, when the configuration of the present modification is employed, the objects to be moved may be only the eleven light emitting devices 14 and the substrate 16, so that the weight thereof may be reduced, and thus, the sliding mechanism 126 as a moving mechanism may be simplified as much. Further, the position of the projection lens 12 may be fixed.

Next, a second modification of the above-described exemplary embodiment will be described.

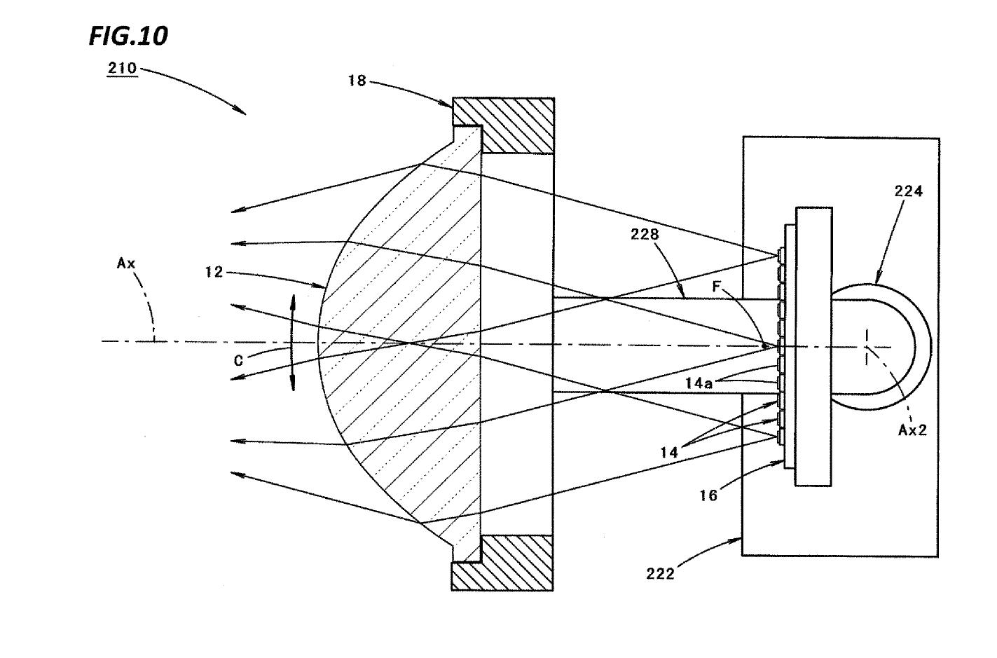

FIG. 10 is the same view as FIG. 3 illustrating a vehicle lamp 210 according to the present modification.

As illustrated in FIG. 10, a basic configuration of the vehicle lamp 210 is the same as that of the vehicle lamp 10 of the above-described exemplary embodiment, but a configuration around a base member 222 is different from the case of the above-described exemplary embodiment.

That is, in the present modification, the base member 222 is supported directly on a lamp body (not illustrated) without the pivoting mechanism 24 of the above-described exemplary embodiment. Further, the substrate 16 supporting the eleven light emitting devices 14 is supported directly on the base member 222. However, the lens holder 18 supporting the projection lens 12 is supported on the base member 222 via a pivoting mechanism 224provided with a pivot arm 228 that extends transversely.

The pivoting mechanism 224 pivots the projection lens 12 together with the lens holder 18 around an axis Ax2 that extends vertically, as indicated by the arrow C in FIG. 10. The axis Ax2 extends to intersect the optical axis Ax behind the rear focal point F of the projection lens 12.

In addition, in the present modification, the additional light distribution patterns PA2, PA3, PAm2, PAm3 are displaced transversely with respect to the additional light distribution patterns PA1, PAm1 by moving the projection lens 12 transversely by driving the pivoting mechanism 224 depending on the traveling situation of the own vehicle.

Even in a case where the configuration of the present modification is employed, it is possible to obtain substantially the same acting effect as in the above-described exemplary embodiment.

Further, when the configuration of the present modification is employed, the objects to be moved may be only the projection lens 12 and the lens holder 18, so that the weight thereof may be reduced, and thus, the pivoting mechanism 224 as a moving mechanism may be simplified as much.

Here, since the axis Ax2 that is a pivot center of the pivot arm 228 is located behind the rear focal point F of the projection lens 12, the pivot radius of the projection lens 12 may be increased. Therefore, the distance between the projection lens 12 and each of the light emitting devices 14 may be suppressed from being considerably changed by the pivot of the projection lens 12.

Further, in the above-described exemplary embodiment and modifications thereof, the numbers represented as specificationsare merely illustrative, and the numbers may, of course, be replaced with other numbers appropriately.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicle lamp comprising:
a projection lens; and
a plurality of light emitting devices arrangedtransversely in parallel to each other behind the projection lens,
wherein an additional high-beam light distribution pattern is additionally formed with respect to a low-beam light distribution pattern,
the additional light distribution pattern is formed by projecting light emitted from each of the light emitting devices forward through the projection lens, and
at least one of the projection lens and the plurality of light emittingdevices is moved in a horizontal plane such that a formation position of the additional light distribution pattern is movable transversely.

2. The vehicle lamp of claim 1, wherein the plurality of light emitting devices is individually turned ON/OFF.

3. The vehicle lamp of claim 1, wherein the projection lens and the plurality of light emitting devices are integrally pivoted in the horizontal plane.

4. The vehicle lamp of claim 2, wherein the projection lens and the plurality of light emitting devices are integrally pivoted in the horizontal plane.

5. The vehicle lamp of claim 1, wherein the projection lens and the plurality of light emitting devices are relatively movable transversely.

6. The vehicle lamp of claim 2, wherein the projection lens and the plurality of light emitting devices are relatively movable transversely.

7. The vehicle lamp of claim 1, wherein a ratio of supply current values of respective light emitting devices is changed as the formation position of the additional light distribution pattern is moved transversely.

8. The vehicle lamp of claim 2, wherein a ratio of supply current values of respective light emitting devices is changed as the formation position of the additional light distribution pattern is moved transversely.

9. The vehicle lamp of claim 3, wherein a ratio of supply current values of respective light emitting devices is changed as the formation position of the additional light distribution pattern is moved transversely.

10. The vehicle lamp of claim 4, wherein a ratio of supply current values of respective light emitting devices is changed as the formation position of the additional light distribution pattern is moved transversely.

11. The vehicle lamp of claim 5, wherein a ratio of supply current values of respective light emitting devices is changed as the formation position of the additional light distribution pattern is moved transversely.

12. The vehicle lamp of claim 6, wherein a ratio of supply current values of respective light emitting devices is changed as the formation position of the additional light distribution pattern is moved transversely.
